(19) United States
(12) Patent Application Publication
(10) Pub. No.: US 2025/0277499 A1
(43) Pub. Date: Sep. 4, 2025

(54) CONNECTING PIECE

(71) Applicant: Jentech Precision Industrial Co., LTD., TAOYUAN CITY (TW)

(72) Inventors: Chang-Chi YEH, TAOYUAN CITY (TW); Po-Yuan SU, TAOYUAN CITY (TW); Fang-Wei YANG, TAOYUAN CITY (TW); Hung-Yi WANG, TAOYUAN CITY (TW)

(21) Appl. No.: 18/967,685

(22) Filed: Dec. 4, 2024

(30) Foreign Application Priority Data
Mar. 1, 2024 (TW) 113107602

(51) Int. Cl. F16B 5/02

(52) U.S. Cl. CPC F16B 5/0216

(57) ABSTRACT

A connecting piece includes a first connecting portion, a second connecting portion and an elastic portion. The elastic portion includes a first subsidiary elastic portion and a second subsidiary elastic portion. The first subsidiary elastic portion and the second subsidiary elastic portion are spaced apart from each other and respectively connected between the first connecting portion and the second connecting portion. The first subsidiary elastic portion has a plurality of first grooves. The first grooves are distributed on a side of the first subsidiary elastic portion away from the second subsidiary elastic portion. The second subsidiary elastic portion has a plurality of second grooves. The second grooves are distributed on a side of the second subsidiary elastic portion away from the first subsidiary elastic portion.

### RELATED APPLICATIONS

This application claims priority to Taiwanese Application Serial Number 113107602, filed Mar. 1, 2024, which is herein incorporated by reference in its entirety.

### BACKGROUND

### Technical Field

The present disclosure relates to connecting pieces.

### Description of Related Art

As the living standard of people continues to increase nowadays, the importance of electronic products in the daily lives of people also becomes higher and higher. Facing to the huge demand for electronic products, the major manufacturers are also working hard to enhance the market competitiveness of their brands.

Specifically, in addition to enhancing the functions and performances of electronic products, how to improve the structural quality of electronic products while reducing the production cost is undoubtedly an issue that various manufacturers highly concern.

### SUMMARY

A technical aspect of the present disclosure is to provide a connecting piece, which can be connected between two objects while flexibly providing a predetermined elasticity.

According to an embodiment of the present disclosure, a connecting piece includes a first connecting portion, a second connecting portion and an elastic portion. The elastic portion includes a first subsidiary elastic portion and a second subsidiary elastic portion. The first subsidiary elastic portion and the second subsidiary elastic portion are spaced apart from each other and respectively connected between the first connecting portion and the second connecting portion. The first subsidiary elastic portion has a plurality of first grooves. The first grooves are distributed on a side of the first subsidiary elastic portion away from the second subsidiary elastic portion. The second subsidiary elastic portion has a plurality of second grooves. The second grooves are distributed on a side of the second subsidiary elastic portion away from the first subsidiary elastic portion.

In one or more embodiments of the present disclosure, the first grooves align with the second grooves.

In one or more embodiments of the present disclosure, a quantity of the first grooves is equal to a quantity of the second grooves.

In one or more embodiments of the present disclosure, the first subsidiary elastic portion has a plurality of third grooves and a plurality of fourth grooves. The third grooves and the fourth grooves are distributed on two opposite sides of the first subsidiary elastic portion. Each of the third grooves is located between adjacent two of the first grooves. Each of the fourth grooves is located between adjacent two of the first grooves.

In one or more embodiments of the present disclosure, the third grooves align with the fourth grooves.

In one or more embodiments of the present disclosure, a quantity of the third grooves is equal to a quantity of the fourth grooves.

In one or more embodiments of the present disclosure, the second subsidiary elastic portion has a plurality of fifth grooves and a plurality of sixth grooves. The fifth grooves and the sixth grooves are distributed on two opposite sides of the second subsidiary elastic portion. The fifth grooves and the sixth grooves are staggered from each other. Each of the fifth grooves is located between adjacent two of the second grooves. Each of the sixth grooves is located between adjacent two of the second grooves.

In one or more embodiments of the present disclosure, each of the fifth grooves aligns with a corresponding one of the third grooves. Each of the sixth grooves aligns with a corresponding one of the fourth grooves.

In one or more embodiments of the present disclosure, the connecting piece further includes a positioning portion. The positioning portion is connected between the first connecting portion and the elastic portion. The first connecting portion has a first outer diameter. The elastic portion has a second outer diameter. The positioning portion has a third outer diameter. The third outer diameter is larger than the first outer diameter and the second outer diameter.

In one or more embodiments of the present disclosure, the first connecting portion has a first thread. The second connecting portion has a second thread.

In one or more embodiments of the present disclosure, the first thread is an inner thread. The second connecting portion has a through hole. The connecting piece further includes a supporting rod. The supporting rod includes a rod body and a threaded portion connected with the rod body. The threaded portion is coupled with the first thread. The rod body is at least partially located in the through hole. The first subsidiary elastic portion and the second subsidiary elastic portion abut against two opposite sides of the rod body.

According to an embodiment of the present disclosure, a connecting piece includes a first connecting portion, a second connecting portion and an elastic portion. The elastic portion extends along a spiral direction to form a spiral shape. The elastic portion is connected between the first connecting portion and the second connecting portion. The elastic portion has a cross-sectional area. The cross-sectional area is perpendicular to the spiral direction and has a rectangular shape.

In one or more embodiments of the present disclosure, the first connecting portion has a first thread. The second connecting portion has a second thread.

In one or more embodiments of the present disclosure, the first thread is an inner thread. The second connecting portion has a through hole. The connecting piece further includes a supporting rod. The supporting rod includes a rod body and a threaded portion connected with the rod body. The threaded portion is coupled with the first thread. The rod body is at least partially located in the through hole and surrounded by the elastic portion. The elastic portion abuts against the rod body.

In one or more embodiments of the present disclosure, the first connecting portion, the second connecting portion and the elastic portion are of an integrally formed structure.

The above-mentioned embodiments of the present disclosure have at least the following advantages:
(1) Since the first connecting portion, the second connecting portion, the elastic portion and the positioning portion are of an integrally formed structure, apart from reducing the production cost of the connecting piece, the structural strength of the connecting piece is also effectively increased.
(2) During the designing process, by changing the quantity and the size of the first grooves, the third grooves and the fourth grooves on the first subsidiary elastic portion, the elasticity of the first subsidiary elastic portion can be adjusted in a simple and easy manner. By changing the quantity and the size of the second grooves, the fifth grooves and the sixth grooves on the second subsidiary elastic portion, the elasticity of the second subsidiary elastic portion can be adjusted in a simple and easy manner. Thus, a user can design the overall elasticity of the elastic portion in a simple and easy manner.
(3) Provided that the first subsidiary elastic portion and the second subsidiary elastic portion are not structurally symmetrical, one of the first subsidiary elastic portion and the second subsidiary elastic portion can achieve a larger elastic deformation then the other when being compressed. Thus, the connecting piece can achieve an appropriate amount of curvature, which can enhance the application flexibility of the connecting piece.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connecting piece according to an embodiment of the present disclosure;

FIG. 2 is a schematic view of the connecting piece of FIG. 1 at another visual angle;

FIG. 3 is a front view of the connecting piece of FIGS. 1-2 along the arrow SA;

FIG. 4 is a sectional view along the sectional line M-M of FIG. 3;

FIG. 5 is a front view of the connecting piece of FIGS. 1-2 along the arrow SB;

FIG. 6 is a front view of the connecting piece of FIGS. 1-2 along the arrow SC;

FIG. 7 is a front view of the connecting piece of FIGS. 1-2 along the arrow SD;

FIG. 8 is a sectional view of a connecting piece according to another embodiment of the present disclosure;

FIG. 9 is a front view of a connecting piece according to a further embodiment of the present disclosure;

FIG. 10 is a sectional view of the connecting piece of FIG. 9; and

FIG. 11 is a sectional view of a connecting piece according to another embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

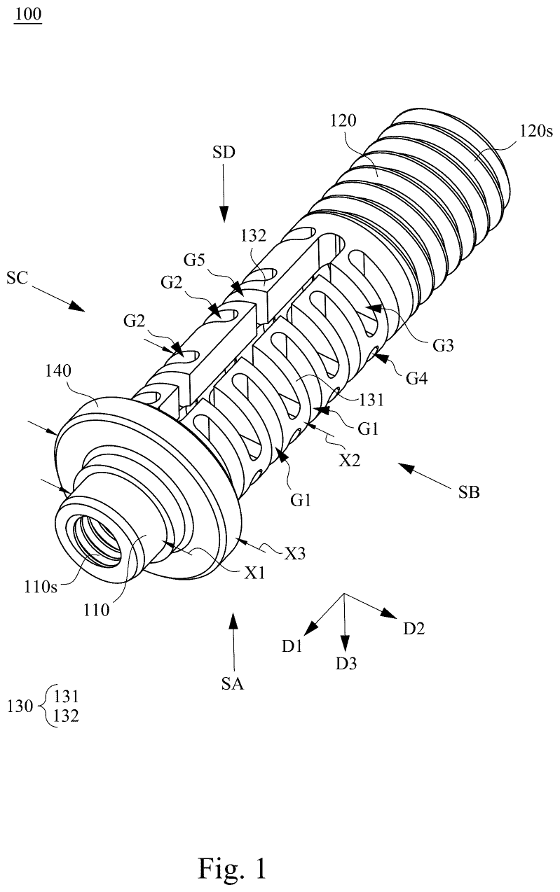

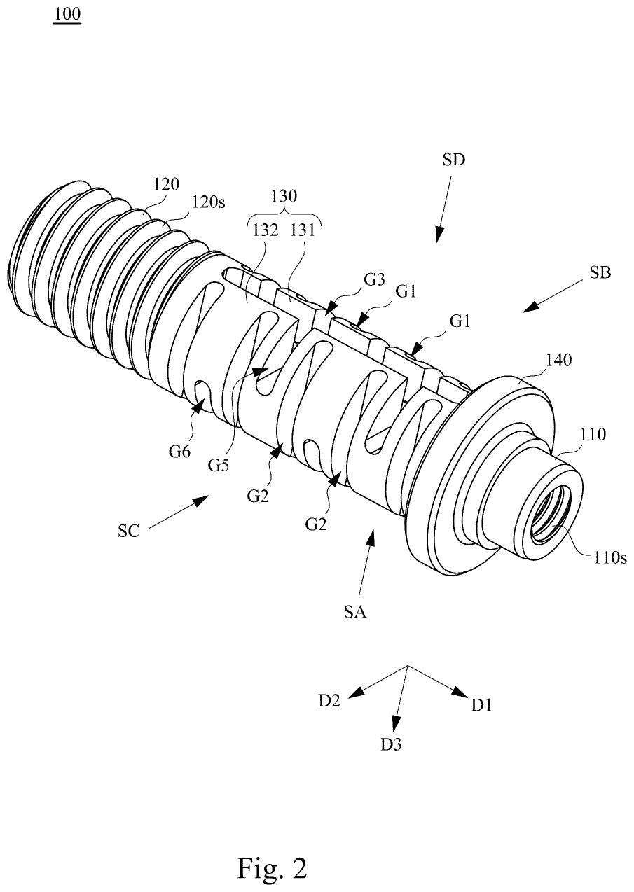

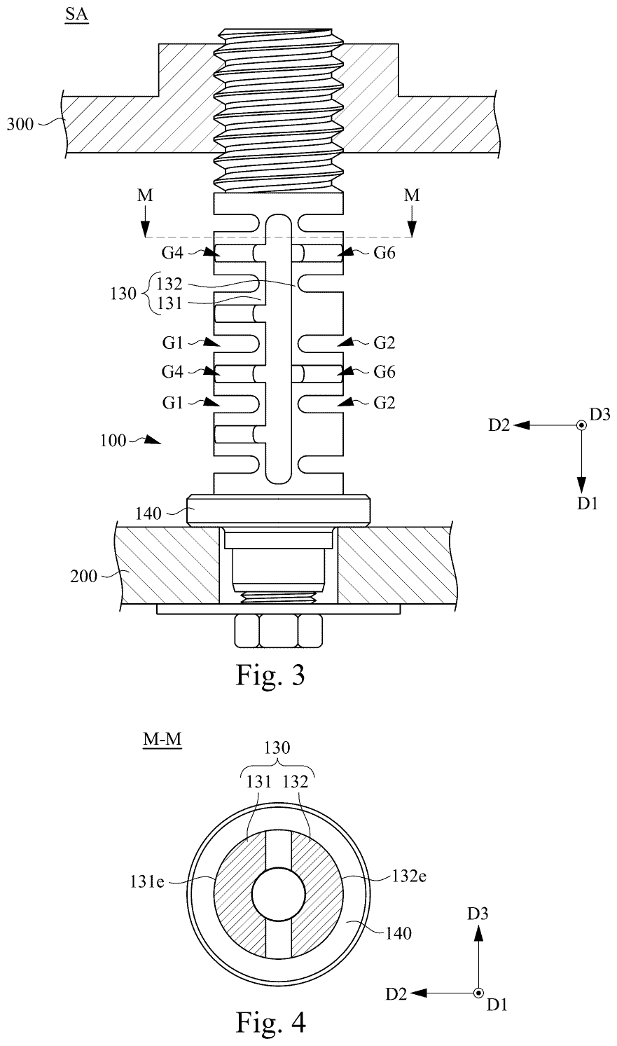

Reference is made to FIGS. 1-2. FIG. 1 is a schematic view of a connecting piece 100 according to an embodiment of the present disclosure. FIG. 2 is a schematic view of the connecting piece 100 of FIG. 1 at another visual angle. In this embodiment, as shown in FIGS. 1-2, a connecting piece 100 includes a first connecting portion 110, a second connecting portion 120 and an elastic portion 130. The elastic portion 130 includes a first subsidiary elastic portion 131 and a second subsidiary elastic portion 132. The first subsidiary elastic portion 131 and the second subsidiary elastic portion 132 are spaced apart from each other. The first subsidiary elastic portion 131 and the second subsidiary elastic portion 132 respectively extend along a first direction D1 and provide a certain amount of elasticity. Moreover, the first subsidiary elastic portion 131 and the second subsidiary elastic portion 132 are respectively connected between the first connecting portion 110 and the second connecting portion 120 along the first direction D1. Therefore, the distance between the first connecting portion 110 and the second connecting portion 120 can be elastically changed. This means the first connecting portion 110 and the second connecting portion 120 can be moved close to or away from each other along the first direction D1. The first connecting portion 110 is configured to connect with a first connecting object 200. The second connecting portion 120 is configured to connect with a second connecting object 300 (for the sake of drawing simplification, the first connecting object 200 and the second connecting object 300 are only shown in FIG. 3). In simple words, the connecting piece 100 can be elastically connected between the first connecting object 200 and the second connecting object 300. For example, the first connecting object 200 and the second connecting object 300 can be but are not limited to modules such as heat sink or back panel.

To be more specific, in this embodiment, the connecting piece 100 further includes a positioning portion 140. As shown in FIGS. 1-2, the positioning portion 140 is connected between the first connecting portion 110 and the elastic portion 130 along the first direction D1. The first connecting portion 110 has a first outer diameter X1. The elastic portion 130 has a second outer diameter X2. The positioning portion 140 has a third outer diameter X3. The third outer diameter X3 is larger than the first outer diameter X1 and the second outer diameter X2, which is beneficial for the positioning portion 140 to abut against the first connecting object 200.

Moreover, for example, as shown in FIGS. 1-2, the first connecting portion 110 has a first thread 110s, and the first thread 110s is an inner thread. In other embodiments, the first thread 110s can be an outer thread. On the other hand, according to the actual situation, the first connecting portion 110 can also be designed to be a rivet or a tenon, for the sake of connection with the first connecting object 200.

Furthermore, for example, as shown in FIGS. 1-2, the second connecting portion 120 has a second thread 120s, and the second thread 120s is an outer thread. In other embodiments, the second thread 120s can be an inner thread. Similarly, according to the actual situation, the second connecting portion 120 can also be designed to be a rivet or a tenon, for the sake of connection with the second connecting object 300.

In practical applications, the first connecting portion 110, the second connecting portion 120, the elastic portion 130 and the positioning portion 140 are of an integrally formed structure. This means the first connecting portion 110, the second connecting portion 120, the elastic portion 130 and the positioning portion 140 are processed from the same piece of material. Accordingly, apart from reducing the production cost of the connecting piece 100, the structural strength of the connecting piece 100 is also effectively increased.

Reference is made to FIG. 3. FIG. 3 is a front view of the connecting piece 100 of FIGS. 1-2 along the arrow SA. As shown in FIG. 3, the connecting piece 100 is connected between the first connecting object 200 and the second connecting object 300 along the first direction D1, while the positioning portion 140 abuts against the first connecting object 200, which is beneficial to fix the relative positions between the connecting piece 100 and the first connecting object 200. In addition, in this embodiment, as shown in FIGS. 1-3, the first subsidiary elastic portion 131 has a plurality of first grooves G1. The first grooves G1 are distributed along the first direction D1 on a side of the first subsidiary elastic portion 131 away from the second subsidiary elastic portion 132. The second subsidiary elastic portion 132 has a plurality of second grooves G2. The second grooves G2 are distributed along the first direction D1 on a side of the second subsidiary elastic portion 132 away from the first subsidiary elastic portion 131. In other words, the first grooves G1 and the second grooves G2 are located on two opposite sides of the elastic portion 130 along a second direction D2, in which the second direction D2 is perpendicular to the first direction D1.

Furthermore, in this embodiment, as shown in FIGS. 1-3, a quantity of the first grooves G1 is equal to a quantity of the second grooves G2, while the first grooves G1 align with the second grooves G2. This means each of the first grooves G1 and a corresponding one of the second grooves G2 are located at the same level in the first direction D1.

Reference is made to FIG. 4. FIG. 4 is a sectional view along the sectional line M-M of FIG. 3. In this embodiment, as shown in FIG. 4, a cross-section of the elastic portion 130 perpendicular to the first direction D1 has a circular shape, while an outer edge 131e of the first subsidiary elastic portion 131 and an outer edge 132e of the second subsidiary elastic portion 132 define a perimeter of this circular shape. In practice, the elastic portion 130 with a circular cross-section can be beneficial to the manufacturing process of the connecting piece 100, and also improve the structural strength of the connecting piece 100. However, in other embodiments, according to the actual situation, the cross-section of the elastic portion 130 perpendicular to the first direction D1 can be non-circular, such as square or polygonal. However, this does not intend to limit the present disclosure.

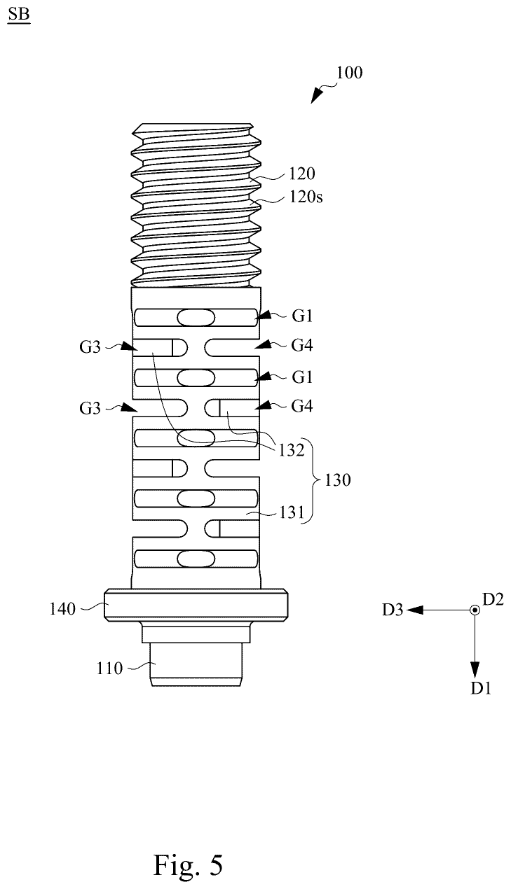

Reference is made to FIG. 5. FIG. 5 is a front view of the connecting piece 100 of FIGS. 1-2 along the arrow SB. In this embodiment, as shown in FIG. 5, the first subsidiary elastic portion 131 has a plurality of third grooves G3 and a plurality of fourth grooves G4. The third grooves G3 and the fourth grooves G4 are distributed on two opposite sides of the first subsidiary elastic portion 131 along the first direction D1. Each of the third grooves G3 is located between adjacent two of the first grooves G1. Each of the fourth grooves G4 is located between adjacent two of the first grooves G1. In other words, the third grooves G3 and the fourth grooves G4 are located on two opposite sides of the first subsidiary elastic portion 131 along a third direction D3, in which the third direction D3 is perpendicular to the first direction D1 and the second direction D2.

Furthermore, in this embodiment, as shown in FIG. 5, a quantity of the third grooves G3 is equal to a quantity of the fourth grooves G4, while the third grooves G3 align with the fourth grooves G4. This means each of the third grooves G3 and a corresponding one of the fourth grooves G4 are located at the same level in the first direction D1.

During the designing process, by changing the quantity and the size of the first grooves G1, the third grooves G3 and the fourth grooves G4 on the first subsidiary elastic portion 131, the elasticity of the first subsidiary elastic portion 131 can be adjusted in a simple and easy manner.

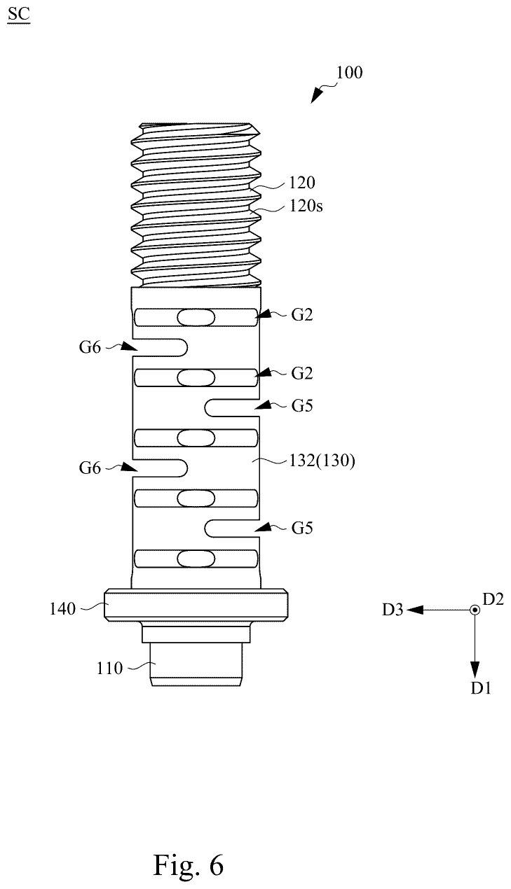

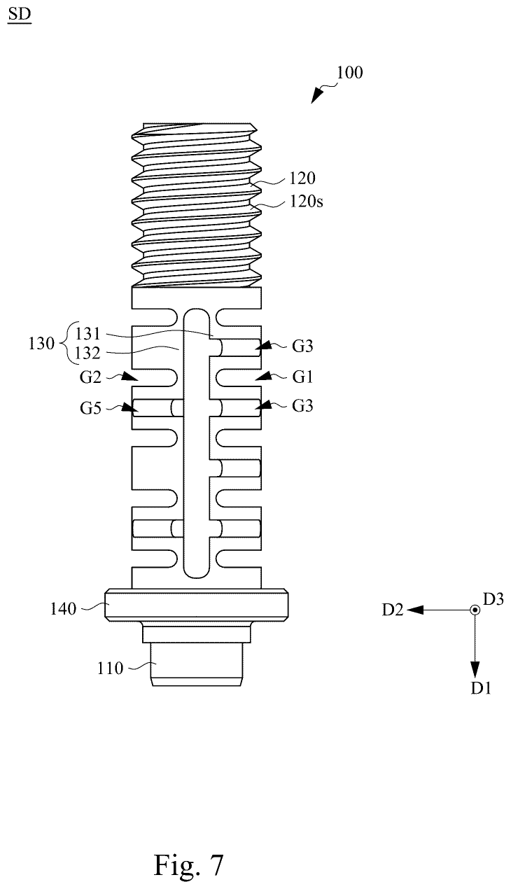

Reference is made to FIGS. 6-7. FIG. 6 is a front view of the connecting piece 100 of FIGS. 1-2 along the arrow SC. FIG. 7 is a front view of the connecting piece 100 of FIGS. 1-2 along the arrow SD. In this embodiment, as shown in FIGS. 6-7, the second subsidiary elastic portion 132 has a plurality of fifth grooves G5 and a plurality of sixth grooves G6. The fifth grooves G5 and the sixth grooves G6 are distributed on two opposite sides of the second subsidiary elastic portion 132 along the first direction D1. The fifth grooves G5 and the sixth grooves G6 are staggered from each other. This means the fifth grooves G5 and the sixth grooves G6 are not located at the same level in the first direction D1. Each of the fifth grooves G5 is located between adjacent two of the second grooves G2. Each of the sixth grooves G6 is located between adjacent two of the second grooves G2.

In addition, as shown in FIG. 7, each of the fifth grooves G5 aligns with a corresponding one of the third grooves G3. Moreover, as shown in FIG. 3, each of the sixth grooves G6 aligns with a corresponding one of the fourth grooves G4. Since the fifth grooves G5 and the sixth grooves G6 are staggered from each other, as shown in FIG. 5, the second subsidiary elastic portion 132 can overlap with at least one of the third grooves G3 and the fourth grooves G4 in the second direction D2.

Similarly, during the designing process, by changing the quantity and the size of the second grooves G2, the fifth grooves G5 and the sixth grooves G6 on the second subsidiary elastic portion 132, the elasticity of the second subsidiary elastic portion 132 can be adjusted in a simple and easy manner.

It is worth to note that, in this embodiment, as shown in FIGS. 1-3 and 5-7, the first subsidiary elastic portion 131 and the second subsidiary elastic portion 132 are not structurally symmetrical. Therefore, the first subsidiary elastic portion 131 and the second subsidiary elastic portion 132 can provide different magnitudes of elasticity, such that a user can design the overall elasticity of the connecting piece 100 in a more flexible manner.

Furthermore, provided that the first subsidiary elastic portion 131 and the second subsidiary elastic portion 132 are not structurally symmetrical, one of the first subsidiary elastic portion 131 and the second subsidiary elastic portion 132 can achieve a larger elastic deformation then the other when being compressed. Thus, the connecting piece 100 can achieve an appropriate amount of curvature, which can enhance the application flexibility of the connecting piece 100.

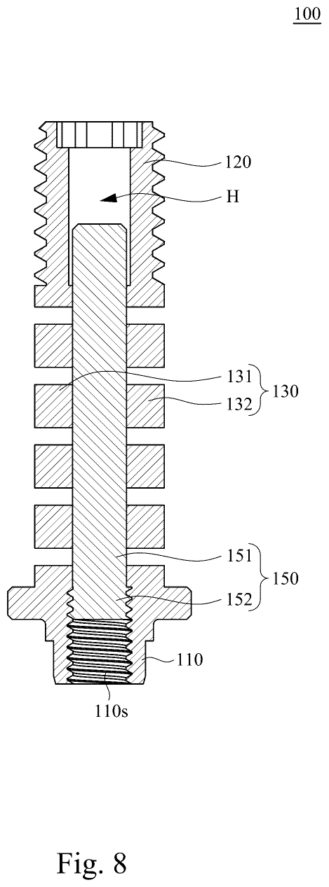

Reference is made to FIG. 8. FIG. 8 is a sectional view of a connecting piece 100 according to another embodiment of the present disclosure. In this embodiment, as shown in FIG. 8, the first thread 110s of the first connecting portion 110 is an inner thread. The second connecting portion 120 has a through hole H. The connecting piece 100 further includes a supporting rod 150. The supporting rod 150 includes a rod body 151 and a threaded portion 152 connected with the rod body 151. The threaded portion 152 of the supporting rod 150 is coupled with the first thread 110s of the first connecting portion 110. The rod body 151 of the supporting rod 150 is at least partially located in the through hole H. The first subsidiary elastic portion 131 and the second subsidiary elastic portion 132 abut against two opposite sides of the rod body 151. In this way, the first subsidiary elastic portion 131 and the second subsidiary elastic portion 132 are unlikely to be bent, such that the overall strength of the connecting piece 100 is effectively increased.

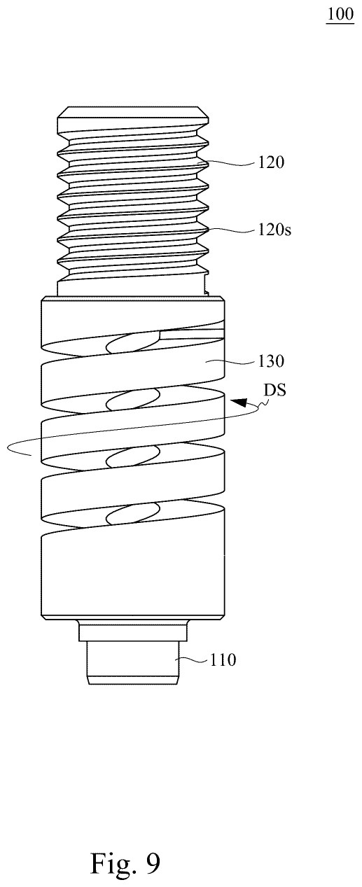

Reference is made to FIG. 9. FIG. 9 is a front view of a connecting piece 100 according to a further embodiment of the present disclosure. As shown in FIG. 9, a connecting piece 100 includes a first connecting portion 110, a second connecting portion 120 and an elastic portion 130. In this embodiment, the elastic portion 130 extends along a spiral direction DS to form a spiral shape. The elastic portion 130 is connected between the first connecting portion 110 and the second connecting portion 120.

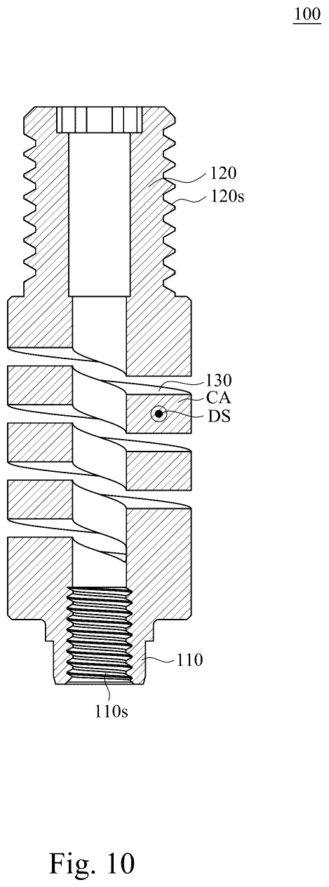

Reference is made to FIG. 10. FIG. 10 is a sectional view of the connecting piece 100 of FIG. 9. In this embodiment, as shown in FIG. 10, the elastic portion 130 has a cross-sectional area CA. The cross-sectional area CA is perpendicular to the spiral direction DS and has a rectangular shape. In this way, the elastic portion 130 is appropriate to be made and processed by machines. Moreover, by changing the dimension and size of the cross-sectional area CA, the elasticity of the elastic portion 130 can be designed in a simple and easy manner. In practical applications, the first connecting portion 110, the second connecting portion 120 and the elastic portion 130 are of an integrally formed structure. This means the connecting piece 100 is processed from the same piece of material. Accordingly, apart from reducing the production cost of the connecting piece 100, the structural strength of the connecting piece 100 is also effectively increased.

Furthermore, as shown in FIGS. 9-10, the first connecting portion 110 has a first thread 110s. The second connecting portion 120 has a second thread 120s. On the other hand, according to the actual situation, the first connecting portion 110 and the second connecting portion 120 can also be designed to be a rivet or a tenon, for the sake of respective connection with the first connecting object 200 and the second connecting object 300 (please refer to FIG. 3 for the first connecting object 200 and the second connecting object 300).

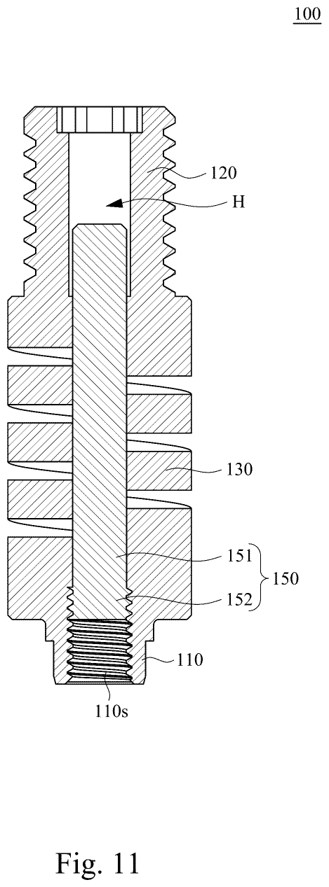

Reference is made to FIG. 11. FIG. 11 is a sectional view of a connecting piece 100 according to another embodiment of the present disclosure. In this embodiment, as shown in FIG. 11, the first thread 110s of the first connecting portion 110 is an inner thread. The second connecting portion 120 has a through hole H. The connecting piece 100 further includes a supporting rod 150. The supporting rod 150 includes a rod body 151 and a threaded portion 152 connected with the rod body 151. The threaded portion 152 of the supporting rod 150 is coupled with the first thread 110s of the first connecting portion 110. The rod body 151 of the supporting rod 150 is at least partially located in the through hole H and surrounded by the spirally-shaped elastic portion 130. The elastic portion 130 abuts against the rod body 151. In this way, the elastic portion 130 is unlikely to be bent, such that the overall strength of the connecting piece 100 is effectively increased.

In conclusion, the aforementioned embodiments of the present disclosure have at least the following advantages:
(1) Since the first connecting portion, the second connecting portion, the elastic portion and the positioning portion are of an integrally formed structure, apart from reducing the production cost of the connecting piece, the structural strength of the connecting piece is also effectively increased.
(2) During the designing process, by changing the quantity and the size of the first grooves, the third grooves and the fourth grooves on the first subsidiary elastic portion, the elasticity of the first subsidiary elastic portion can be adjusted in a simple and easy manner. By changing the quantity and the size of the second grooves, the fifth grooves and the sixth grooves on the second subsidiary elastic portion, the elasticity of the second subsidiary elastic portion can be adjusted in a simple and easy manner. Thus, a user can design the overall elasticity of the elastic portion in a simple and easy manner.
(3) Provided that the first subsidiary elastic portion and the second subsidiary elastic portion are not structurally symmetrical, one of the first subsidiary elastic portion and the second subsidiary elastic portion can achieve a larger elastic deformation then the other when being compressed. Thus, the connecting piece can achieve an appropriate amount of curvature, which can enhance the application flexibility of the connecting piece.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connecting piece, comprising:
a first connecting portion;
a second connecting portion; and
an elastic portion comprising a first subsidiary elastic portion and a second subsidiary elastic portion, the first subsidiary elastic portion and the second subsidiary elastic portion being spaced apart from each other and respectively connected between the first connecting portion and the second connecting portion, the first subsidiary elastic portion having a plurality of first grooves, the first grooves being distributed on a side of the first subsidiary elastic portion away from the second subsidiary elastic portion, the second subsidiary elastic portion having a plurality of second grooves, the second grooves being distributed on a side of the second subsidiary elastic portion away from the first subsidiary elastic portion.

2. The connecting piece of claim 1, wherein the first grooves align with the second grooves.

3. The connecting piece of claim 1, wherein a quantity of the first grooves is equal to a quantity of the second grooves.

4. The connecting piece of claim 1, wherein the first subsidiary elastic portion has a plurality of third grooves and a plurality of fourth grooves, the third grooves and the fourth grooves are distributed on two opposite sides of the first subsidiary elastic portion, each of the third grooves is located between adjacent two of the first grooves, each of the fourth grooves is located between adjacent two of the first grooves.

5. The connecting piece of claim 4, wherein the third grooves align with the fourth grooves.

6. The connecting piece of claim 4, wherein a quantity of the third grooves is equal to a quantity of the fourth grooves.

7. The connecting piece of claim 4, wherein the second subsidiary elastic portion has a plurality of fifth grooves and a plurality of sixth grooves, the fifth grooves and the sixth grooves are distributed on two opposite sides of the second subsidiary elastic portion, the fifth grooves and the sixth grooves are staggered from each other, each of the fifth grooves is located between adjacent two of the second grooves, each of the sixth grooves is located between adjacent two of the second grooves.

8. The connecting piece of claim 7, wherein each of the fifth grooves aligns with a corresponding one of the third grooves, each of the sixth grooves aligns with a corresponding one of the fourth grooves.

9. The connecting piece of claim 1, further comprising:
a positioning portion connected between the first connecting portion and the elastic portion, the first connecting portion having a first outer diameter, the elastic portion having a second outer diameter, the positioning portion having a third outer diameter, the third outer diameter being larger than the first outer diameter and the second outer diameter.

10. The connecting piece of claim 1, wherein the first connecting portion has a first thread, the second connecting portion has a second thread.

11. The connecting piece of claim 10, wherein the first thread is an inner thread, the second connecting portion has a through hole, the connecting piece further comprises:
a supporting rod comprising a rod body and a threaded portion connected with the rod body, the threaded portion is coupled with the first thread, the rod body is at least partially located in the through hole, the first subsidiary elastic portion and the second subsidiary elastic portion abut against two opposite sides of the rod body.

12. A connecting piece, comprising:
a first connecting portion;
a second connecting portion; and
an elastic portion extending along a spiral direction to form a spiral shape, the elastic portion being connected between the first connecting portion and the second connecting portion, the elastic portion having a cross-sectional area, the cross-sectional area being perpendicular to the spiral direction and having a rectangular shape.

13. The connecting piece of claim 12, wherein the first connecting portion has a first thread, the second connecting portion has a second thread.

14. The connecting piece of claim 13, wherein the first thread is an inner thread, the second connecting portion has a through hole, the connecting piece further comprises:
a supporting rod comprising a rod body and a threaded portion connected with the rod body, the threaded portion is coupled with the first thread, the rod body is at least partially located in the through hole and surrounded by the elastic portion, the elastic portion abuts against the rod body.

15. The connecting piece of claim 12, wherein the first connecting portion, the second connecting portion and the elastic portion are of an integrally formed structure.
